(19) United States
(12) Patent Application Publication
(10) Pub. No.: US 2026/0349504 A1
(43) Pub. Date: Nov. 5, 2026

(54) Automated Interactive Simulations Through Fusion Of Interaction Tracking And Artificial Intelligence

(71) Applicant: SimX, Inc., San Francisco, CA (US)

(72) Inventors: Karthik Venkataraman Sarma, San Francisco, CA (US); Jennifer Sara Polson, Seattle, WA (US)

(73) Assignee: SimX, Inc., San Francisco, CA (US)

(21) Appl. No.: 19/488,513

(22) PCT Filed: May 30, 2024
(86) PCT No.: PCT/US2024/031715

§ 371 Date: Nov. 26, 2025

Related U.S. Application Data
(60) Provisional application No. 63/505,373, filed on May 31, 2023.

(51) Int. Cl. G06F 3/01; G06N 3/0475; G06T 13/40

(52) U.S. Cl. CPC G06F 3/013; G06F 3/016; G06F 3/017; G06N 3/0475; G06T 13/40; G06F 3/015; G06F 2203/011

(57) ABSTRACT

Systems and methods are described herein for fusing tracking interaction and artificial intelligence within augmented and virtual reality environments. The techniques may enhance the reactions to user interactions within simulation scenes. Additionally, the techniques allow participants to interact naturally with the simulation without requiring the user to use any immersion-ruining user interface elements. By enabling trainees to act naturally as they would in real life without UI elements or a human moderator, AR and VR-based training becomes more effective and less expensive.

### INCORPORATION BY REFERENCE; DISCLAIMER

Each of the following applications are hereby incorporated by reference: application No. PCT/US24/31715 filed on May 30, 2024; application No. 63/505,373 filed on May 31, 2023. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to artificial intelligence (AI) in extended reality applications, such as augmented and virtual reality applications. In particular, the present disclosure relates to methods and systems for fusing interaction tracking in virtual and augmented reality environments with an AI-based simulation engine.

### BACKGROUND

Augmented reality (AR) and virtual reality (VR) both encompass interactive technologies that create immersive environments but differ in how they blend virtual and real-world elements. Augmented reality overlays virtual content onto the real world, enhancing the user's perception of their surroundings. It typically involves using a device, such as a smartphone or AR glasses, to display digital information, images, or three-dimensional models that are superimposed onto the user's view of the physical environment.

Virtual reality, on the other hand, transports the user to a completely simulated digital environment. By wearing a VR headset, users are immersed in a computer-generated world that may be highly realistic or fantastical. VR enables users to interact with and explore a virtual environment through specialized input devices such as controllers or hand-tracking systems. Both AR and VR are used in various applications such as gaming, education, navigation, architecture, healthcare, and industrial training.

One challenge with extended reality (XR) simulations, including AR, VR, and mixed reality simulations, is creating scenes that are appropriately and fully reactive to the interactions of participants. In complex simulation scenes, such as simulations of medical procedures in a training simulation, human facilitators are often involved. In particular, the human facilitator is provided with a control panel for the simulation and uses the control panel to perform real-time adjustments to create realistic responses to user interactions. However, this approach requires a human to continuously monitor and control the simulation, which is expensive. Further, the approach may be immersion-breaking as there may be delays and/or errors in the inputs provided to the simulation through the control panel.

Another approach is to have a participant control the simulation through menus, buttons, and/or other user interface (UI) elements. For example, in a medical simulation/training scenario, a participant may have a menu item where the user may select which medication to administer to a virtual patient. However, this approach also has a negative impact of ruining the immersion of the system, which may reduce the effectiveness of a training simulation as there are no buttons or menus in the real-world scenario being simulated.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example dataflow diagram of an AI understanding model in accordance with one or more embodiments;

FIG. 3 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. General Overview

Systems and methods are described herein for fusing tracking interaction and artificial intelligence within extended reality environments, including augmented and virtual reality environments. The techniques may enhance the reactions to user interactions within simulation scenes. Additionally, the techniques allow participants to interact naturally with the simulation without requiring the user to use any immersion-ruining user interface elements. By enabling trainees to act naturally as they would in real life without UI elements or a human moderator, XR training, including AR and VR-based training, becomes more effective and less expensive.

In some embodiments, an AR or VR system fuses raw sensed actions and an artificial intelligence (AI) model that (a) interprets the actions into a spectrum of responses from the scene and (b) implements the responses as a reaction to a given scenario. The AR or VR system may capture and record various physical measurements/interactions of a participant within a simulation. For example, the AR or VR system may capture/record one or more of sounds uttered by the user, the current position of the user within the AR/VR environment, the position of individual body parts of the user (e.g., arm, leg, hand, etc.), the direction the user is looking (e.g., through eye position/tracking), and the position of virtual/real world objects being used by the participant. The captured data may be used to construct, train, and continuously finetune an AI understanding model of the virtual scene. The AR or VR system may further include a translation layer between the physical measurements, the AI understanding model, and the virtual scene such that the AI model outputs (based on inputs from the physical measurement capture/recording and simulation state data) are translated to outputs that impact the scene.

In some embodiments, the AI understanding model resides and is processed within one or more processing units. The model receives as input information about the scene from the virtual simulation environment system as well as raw information about the participant(s) from the participant recording/sensing system. The AI understanding model processes these inputs in order to create inferences to drive the evolution of the virtual simulation environment. The model may use audio speech to text inference to decode audio recordings into text-based inputs. Additionally or alternatively, the model may use pose and gesture recognition inference to decode physical movements into categorical inputs. The model fuses measurement/tracking information from the participants from the real-world with virtual-world coordinates to measure how physical interactions map to the virtual environment. The model also fuses input about the simulation state from the environment model with this information. Using these inputs (either in their raw or inferred form), the model infers one or more reactions in the simulation scene, based on the environment model. For example, the model may infer that non-player simulated characters in the scene would respond via generated voice or virtual actions (i.e. virtually walking around the scene, interacting with other characters, etc.). The model may make use of a large language system, such as a generative language model, to create inferences based on text/speech inputs and to infer text/speech responses, or to infer scene responses based on text-based background or descriptions. In some embodiments, the model may use text to speech inference to create audio responses. Additionally or alternatively, the model may integrate a physical, engineering, or physiological model to infer biological, mechanical, or physical responses from inferred participant actions. Additionally or alternatively, the model may also infer whether specific objectives or other actions have been completed by participants based on measured activity. Additionally or alternatively, physical measurements may be used to infer the emotional or mental state of participants. Additionally or alternatively, these measurements may be used to infer social and behavioral interactions (such as eye contact, etc.) between participants and/or simulated non-player characters.

One or more embodiments described in this Specification and/or recited in the claims may not be included in this General Overview section.

### 2. AI-Based Simulation System Architecture

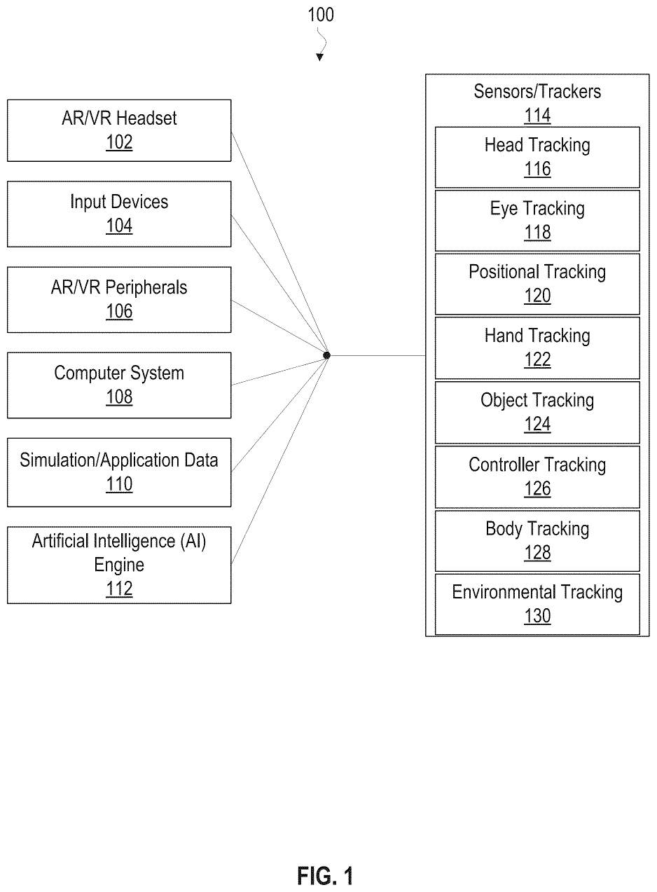

FIG. 1 illustrates a system 100 in accordance with one or more embodiments. As illustrated in FIG. 1, system 100 includes AR/VR headset 102, input devices 104, sensors/trackers 114, AR/VR peripherals 106, computer system 106, simulation application data 110, and AI engine 112. In one or more embodiments, system 100 may include more or fewer components than the components illustrated in FIG. 1.

AR/VR headset 102 is a device that is worn by a participant in a simulation training to immerse the participant in an augmented or virtual reality scene. An AR headset combines real-world views with virtual overlays and digital information. An AR headset allows users to see and interact with virtual content while maintaining awareness of their physical surroundings. The AR headset may further use the physical surroundings to render virtual overlays (e.g., such as a virtual avatar projection over a medical training manikin that is present in the physical space) and generate reactions based on interactions with real world objects and/or the virtual objects projected by the AR headset into the physical space. In some embodiments, an AR system may project virtual patients, instruments, and/or characters into an environment, or may display additional environmental elements in the scene. AR headsets may include a transparent or semi-transparent display, which may be a see-through lens or a screen that displays an image of the physical space (e.g., using a camera on the front of the headset). A VR headset provides a display that immerses the participant in a virtual environment, which may limit the participants vision/awareness of their physical surroundings. AR/VR headset 102 may be a dedicated device built specifically for AR/VR applications or may be a multi-function device such as a smartphone, which may optionally be strapped to a participant's head using an accessory device. In some embodiments, the VR system displays a scene with tools, characters, and/or other environmental elements in virtual space.

Input devices 104 include devices that a participant may use to provide input to AR/VR headset. For example, AR/VR headset 102 may include handheld controllers or other input devices that allow a participant to start a new simulation, manipulate objects in the environment, etc. As another example, AR/VR headset 102 may include an input device representing a training tool, such as a real-world medical device or object representing a medical device (e.g., bag and mask, stethoscope, scalpel, syringe, IV bag, x-ray machine, MRI machine, etc.). Controllers may include buttons, triggers, touchpads, embedded markers, accelerometers, and/or other motion-sensing/position tracking capabilities. In some embodiments, AR/VR headset 102 may use hand tracking as an input modality where a participant's hands/fingers act as input devices.

Sensors/trackers 114 track a participant's movements and translate them into the augmented/virtual reality environment. Sensors/trackers may be embedded in the headset, placed on the participant, and/or positioned within the surrounding physical space. Sensors may capture a participant's position, orientation, and movements, among other data. In some embodiments, sensors/trackers include sensors/trackers to perform:
Head tracking 116: AR/VR headset 102 may incorporate sensors, such as accelerometers, gyroscopes, and magnetometers, to track the user's head movements and orientation, which allows the virtual environment to adjust accordingly to provide an immersive experience. Additionally, there may be cameras or other sensors set up within the scene to track the positioning of the head, as well as to track changes in facial expressions of the participants.
Eye tracking 118: AR/VR headset 102 may track where the user is looking. Eye tracking may be computed/inferred from the head position captured via the head tracking sensors and/or via additional sensors, such as a pupillometry sensor or an infrared light that creates a reflection used to measure the distance between the pupil center and the reflection of the cornea.
Positional tracking 120: System 100 may include external sensors and/or cameras to track the user's position in a physical space. The sensors may capture the movement of markers or built-in sensors on the headset to provide precise tracking of the user's location as the user moves within the augmented or virtual reality environment.
Hand tracking 122: System 100 may include cameras, depth sensors, and/or infrared sensors to track hand movements and gestures without the need for handheld controllers. The sensors may capture hand movements and/or finger articulations.
Object tracking 124: System 100 may include sensors and cameras to track object other than the user in a physical space. Similar to hand tracking 122, system 100 may use cameras, depth sensors and/or infrared sensors to track object movements. Additionally or alternatively, electromagnetic markers and/or built in sensors may be affixed/included in the object to provide data about the object's position and orientation within the augmented or virtual reality environment.
Controller tracking 126: Handheld controllers may include built-in sensors, such as accelerometers and gyroscopes, that capture the controller's orientation and movements. The controllers may include buttons, joysticks, and/or other input devices that allow the user to navigate through menus and interfaces projected/displayed on VR headset.
Body tracking 128: Advanced AR and VR training systems may incorporate full-body tracking, which involves capturing movements of the participant's entire body. To capture full-body movements, system 100 may include motion-capture cameras, depth sensors, and/or wearable devices (e.g., full body suits with embedded sensors).
Environmental tracking 130: VR training systems may utilize sensors, microphones and/or cameras placed in the physical environment or affixed to the headset 102 to track the user's speech and movements and to enforce safety protocols. For example, sensors may help prevent collisions with real-world objects and create a boundary within which the user may freely move.

AR/VR peripherals 106 includes accessories and/or other devices that are separate/external from the headset that may enhance the training experience. For example, AR/VR peripherals 106 may include haptic feedback devices, which provide tactile sensations to simulate a real-world environment, or motion platforms that simulate physical movement to enhance immersion. AR/VR peripherals 106 may be paired wirelessly or connected via a physical wire with the AR/VR headset 102 and/or computer system 108. Additionally or alternatively, AR/VR peripherals 106 may include electromagnetic markers, which may include a coil of wire that generates an electromagnetic field that may be tracked by sensors/trackers 114 (e.g., by triangulating the signals received from multiple sensors to determine a marker's position and orientation in real-time).

Computer system 108 includes one or more hardware processors for running AR/VR software and rendering overlays/complex graphics in the augmented or virtual reality environment. Computer system 108 may process a participant's inputs and generate the virtual world, including the reactions within the environment to the participant's inputs. The computer may be embedded directly within AR/VR headset 102 or may be an external device that communicates wirelessly or via a tethered connection with AR/VR headset 102. Illustrative, non-limiting computer architectures are discussed further below.

Simulation application data 110 includes software code and other data, which may be executed by computer system 108 to provide the augment or virtual reality environment and interactive experiences. Simulation applications may be developed specifically for training purposes, simulating real-world scenarios, or providing educational content. In some embodiments, a runtime environment may load and execute code to simulate various scenarios, which may be defined through an authoring application.

AI engine 112 is a software component or system that powers machine understanding and learning from data, which is used to generate real-time reactions to user inputs within the augmented or virtual reality environment. AI engine 112 may serve as the underlying infrastructure that is responsible for processing user inputs, inferring information about the scenario, making decisions about how to react, generating responses, and performing tasks autonomously. AI engine 112 may incorporate machine learning algorithms and models to make decisions and generate intelligent responses that are not hard-coded into the system, which allows the system to adapt and evolve over time without any programming changes. AI engine may include one or more of the following components:
Data Processing: AI engine 112 may process and ingest large volumes of data, which may include data streamed/sampled at a high frequency from sensors/trackers 114. AI engine 112 may apply data pre-processing techniques to clean, transform, and organize the data for analysis.
Machine Learning: AI engine 112 may use machine learning algorithms and models to learn from data, identify patterns, and make predictions or decisions based on the learned information. Models may be utilized for classification (e.g., identifying the sentiment of spoken audio) and/or generation (e.g., producing an encoded action or set of actions for an agent to perform within the scenario). A machine learning algorithm that may be iterated to learn a target model f that best maps to a set of input variables to an output variable. The machine learning algorithm may iterate over a training dataset comprising multiple examples of sensor/tracking data and reactions, which may be labelled (e.g., correct or incorrect reaction). The machine learning algorithm may use supervised learning, unsupervised learning, and/or reinforcement learning to train a ML model based on the training dataset. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.
Deep Learning: Deep learning is a subset of machine learning that involves learning using neural networks with multiple layers. Deep learning algorithms may be used for tasks like image and speech recognition, natural language processing, and complex pattern recognition. Deep learning methods may include architectures such as convolutional neural networks, recurrent neural networks, self-attention mechanisms, and transformers. Training paradigms may be used to optimize the models for specific tasks and might include training a model from random initialization, finetuning specific components of the architecture, or utilizing a pretrained, generalizable model.
Reasoning and Inference: AI engine 112 may employ logical reasoning and inference mechanisms to derive insights, draw conclusions, and make logical deductions based on the available data and knowledge. These may include knowledge distillation, causal graphs, mixture-of-experts, rule-based, and/or other inference models.
Knowledge Representation: AI engine 112 may include methods for representing learned knowledge in a structured format. The structured format may optimize the system's capacity to organize and utilize domain-specific knowledge to perform decision-making and problem-solving tasks. Knowledge may be represented in logical or frame representations, semantic networks, ontologies, and/or production rules.
Natural Language Processing (NLP): NLP techniques may be used by AI engine 112 to understand and process human language, including speech recognition, language understanding, and language generation capabilities. Underlying methods may include speech-to-text transcription, tokenization, part-of-speech tagging, named entity recognition for processing natural language.
Translation layer: AI engine 112 may include a translation layer to integrate the AI functions with a simulation application. For example, the translation layer may translate the output of an ML model (e.g., a deep learning/neural network model prediction) to code/instructions that cause changes in the augmented/virtual reality environment.

In some embodiments, system 100 may further include components for synchronizing a simulation when there are multiple participants involved. For example, system 100 may include components that concurrently broadcast a medical training session such that different participant headsets concurrently project the same scene though from different physical locations as described in U.S. Pat. No. 10,672,288, which is incorporated by reference herein.

### 3. AI Understanding Model With Participant Recording/Sensing

One or more users may be immersed in a virtual world or augmented reality environment. This immersion may be through the use of headset systems or via computer screen systems, with or without additional tracking mechanisms (such as worn body trackers, external camera trackers, or inside-out internal trackers, etc.) as previously discussed. The mechanisms measure the position of each user in the physical world and transmit this position in real time to the processing unit. The measurement may include measurement of individual portions of the body, such as the head, legs, hands, individual fingers, etc. Additionally or alternatively, audio recording of the voice and other spoken sounds may be measured by microphone in real-time and synchronized temporally with the positional measurements. Additionally or alternatively, physical real-world items (such as a stethoscope or a drill, etc.) may be tracked positionally in the system, and individually interactable components on the physical item may also be tracked (such as an on/off trigger, etc.) and measured in synchronicity. Additionally or alternatively, physical end-items may also be tracked, such as a physical manikin simulator, or physical maintenance item, etc. Additionally or alternatively, the real physical environment (such as chairs, tables, beds, doors, etc.) may also be tracked. Various measurements may be sent in real-time to the processing unit, which may be on a local computer, or may be accessed, via the internet, in the cloud (e.g. cloud-hosted or cloud-based). Additionally or alternatively, biomarker sensors (such as pupillometry, galvanic skin response, heart rate, etc.) may also be used to measure participant physiology in real time.

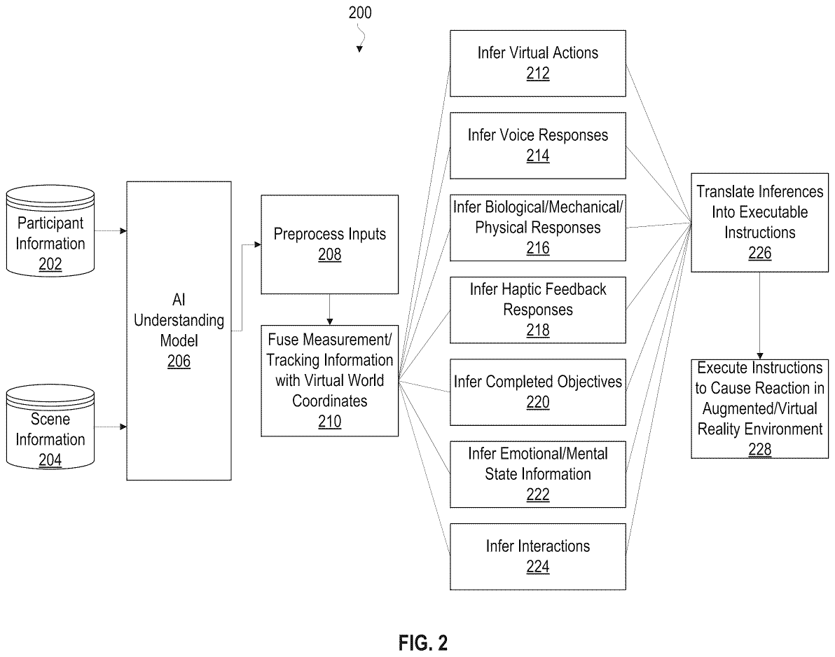

FIG. 2 illustrates an example dataflow diagram 200 of an AI understanding model in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

AI understanding model 206 receives, as input, participant information 202 from the recording/sensing system and scene information 204 from the virtual simulation environment system. Participant information 202 may include visual inputs (e.g., images or video streams of the physical space, images or video streams of participants face, head, and/or body), audio inputs (e.g., voice commands), biomarker inputs for one or more participants (e.g., pupil positions, changes in electrical resistance in the skin, heart rate measurements, etc.), position/orientation information of one or more participants, and/or other participant information (e.g., position of individual fingers, hand tracking measurements, etc.). Scene information 204 may include information about the position of virtual characters/avatars, real or virtual objects, state information for a given simulation (e.g., the current state of a virtual patient in a medical simulation), environmental data associated with the scene (e.g., weather information, altitude measurements, etc.) and/or other information about the scene being concurrently rendered on the participant headsets.

In some embodiments, AI understanding model 206 preprocesses the inputs (operation 208). This may involve post-hoc data processing methods or stream processing. For example, the model may decode audio recordings into text based input. Additionally or alternatively, the model may transform/normalize the sensor measurements by performing one or more of the following:
Handling missing data: Missing values are addressed through techniques like imputation (replacing missing values with estimated values) or deletion of incomplete records.
Removing duplicates: Duplicate records are identified and eliminated to avoid redundancy and ensure data accuracy.
Handling outliers: Outliers, which are extreme values that deviate significantly from the norm, can be addressed through techniques like trimming (capping extreme values) or imputation with statistical measures.
Standardizing formats: Inconsistent formats for variables, such as dates or categorical data, are standardized to ensure consistency and ease of analysis.
Correcting inconsistencies: Inconsistencies in data entry, such as spelling errors or inconsistent naming conventions, are resolved to maintain data integrity.
Feature engineering: Creating new variables or transforming existing variables to capture important information or relationships in the data.
Scaling and normalization: Scaling numeric variables or normalizing data to ensure all variables are on a similar scale, facilitating fair comparisons.
Encoding categorical variables: Converting categorical variables into numerical representations, such as one-hot encoding or label encoding, for analysis.
Aggregation and summarization: Summarizing data at different levels (e.g., daily, monthly, or by category) to derive insights and facilitate analysis.
Stream synchronization: Joining multiple continuous streams of data (e.g., collected inputs from the sensors used in 202 and 204) such that their measurements are appropriately aligned in the temporal dimension.
   Additionally or alternatively, the model may use pose and gesture recognition inference to decode physical movements into categorical inputs (e.g., the movements may be mapped to descriptive labels indicating how the movement is interpreted).

In some embodiments, AI understanding model 206 fuses measurement/tracking information from the participants from the real-world with virtual-world coordinates to measure how physical interactions map to the virtual environments (operation 210). These fusion tasks may involve one or more data stream tracked in the physical environment and data stream from the virtual scene, and these data types may be one from or more modalities. The model may further fuse input information about the simulation state from an environmental model with this information. For example, AI understanding model 206 may create a fused entry, based on the eye tracking information and spatial information within the simulation, that indicates what object or character a participant is currently looking at within the virtual environment. As another example, AI understanding model 206 may fuse a hand/finger tracking measurements with the virtual environment to indicate a current object that the user is touching or pointing towards within the virtual world. As another example, AI understanding model 206 may fuse a user's voice with head tracking measurements and the location of a virtual character in the virtual environment to determine the character to whom the user is speaking. As another example, AI understanding model 206 may fuse a user's voice with the location tracking measurements of another user to determine that the initial user was referring to the second user. The fused data may create more complex inputs in the AI model to create more powerful inferences.

In some embodiments, AI understanding model 206 generates one or more inferences based on the inputs. For example, AI understanding model 206 may infer virtual actions (operation 212) voice responses (operation 214), biological/mechanical/physical responses (operation 216), haptic feedback responses (operation 218), objectives that have been completed (operation 220), emotional/mental state information of participants (operation 222), and/or social/behavioral interactions (e.g., eye contact, body language, voice pitch, etc.) between participants and/or non-player characters (operation 224). The inferences may be generated by creating a feature vector using raw sensor and/or fused data, which may be used to perform a forward pass through one or more trained machine learning models to generate the predictions based on patterns learned from a training dataset.

A translation layer of AI understanding model 206 next translates the inferences into executable instructions for changing the environment to react to the current set of inputs (operation 226). For example, the translation layer may create instructions that cause the position, orientation, emotional state, and/or voice timbre to change based on the inferences. As another example, the translation layer may create an audio response that is audible to one or more participants in the training session. The audio response may encode directional information such that different participants hear the audio signal relative to their current position (e.g., the volume/effects of the left/right ear in a stereo headset may vary depending on where the participant is located relative to a source position from which the audio signal originates within the simulated environment. As another example, the haptic feedback of a handheld simulation tool (e.g., an object simulating a medical tool) may change based on the inferences output by the AI model. Additionally or alternatively, the current state/objectives of a training scenario may be updated, and the change in state/objectives may be communicated autonomously to the participants.

The instructions are then executed to cause the reaction to be rendered/projected in the augmented/virtual reality environment (operation 228).

AI understanding model 206 may autonomously generate and guide complex reactions to user inputs within training simulations even though the reactions are not explicitly coded into the training applications data. For example, a participant in a medical training simulation may look at a simulated nurse and say, “Please give 10 milligrams of epinephrine IM immediately.” The audio command, eye tracking data, position, etc. may be fed as input to the AI understanding model, which may preprocess the data and apply one or more trained ML models to generate a set of inferences on how to react. The AI understanding model may infer that the participant is issuing the command to the nurse based on the content of the audio, the eye tracking data, and/or other sensory inputs. The AI understanding model may further infer the actions that the virtual nurse should perform, such as determining that the nurse should walk to the medication storage area, fill a syringe with the medication, walk back to a virtual patient, and inject the medication in the appropriate area. The AI understanding model may provide instructions to the scenario system about the location of the epinephrine and any associated tools within the scene, the procedural steps for administering an intramuscular injection, and the timing with which this task needs to be completed. The AI understanding model may further infer the response from the virtual patient responsive to receiving the injection based on the amount of medication injected, the current state of the patient, and the virtual physiological characteristics defined for the patient. Thus, the system allows full immersion in the scene without requiring the user to navigate through complex menus/UI elements to select actions to execute (e.g., a menu item to “Give Epinephrine”).

### 4. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 5. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

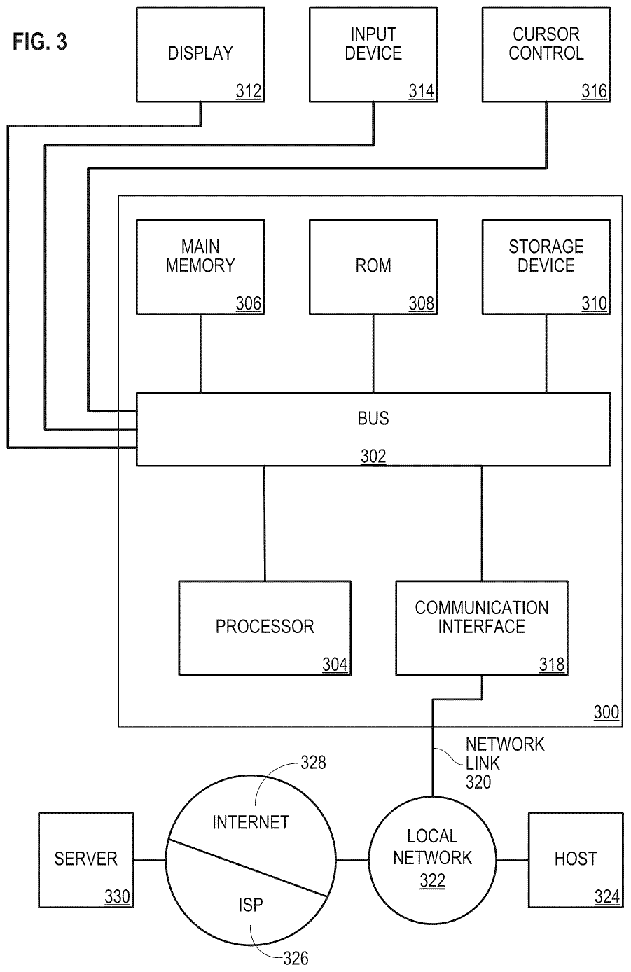

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### 6. Illustrative Embodiments

In an embodiment in a VR environment, a simulation may place in an intensive care unit, designed around a patient requiring care from multiple members of the care team. For example, a pediatric patient with asthma may require care from a doctor, several nurses, a respiratory therapist, and other clinical professionals. The training goals may require both procedural competencies and interprofessional competencies, and have specific learning objectives for each participant in the simulation. Within the simulation, one or more participants and one or more non-player characters may comprise the total care team. Participants may be in one or more physical locations. In an embodiment, there are two participants in different locations, a first participant simulating the role of a doctor in a physical simulation space in location A and a second participant simulating the role of an ICU nurse in a physical simulation space location B. These two participants will interact with four virtual participants within the scenario: a pediatric patient with an unknown respiratory condition; a first non-player character-the pediatric patient's father; a second non-player character-a simulated nurse; and a third non-player character-a simulated respiratory therapist. The hospital room will be set up to have XYZ in the scene.

### Simulation Setup

To conduct the simulation, each participant wears a VR/AR headset and holds two handheld controllers. The VR/AR headsets each contain a plurality of sensors to capture position, orientation, and movement of the head, as well as pupillometric sensors to detect eye localization. Microphones, contained in the headset, will detect audio signals. Each participant and 402 also wears biometric sensors capable of detecting heart rates and perspiration, respectively, as well as bodily sensors placed on their limbs. Within the physical simulation spaces A and B, there will be two cameras 424 and 425 tracking the positioning and facial expressions of the human participant.

These sensors will also be connected via networked connection to the simulation system for processing by AI understanding models. This embodiment will have several instances of fusion tracking:
A. Registration of the location of the participants in their physical locations to the learner environment to align with the location of the characters within the scene. For this, one component of the AI understanding model will process the raw data from position, orientation, and movement sensors, bodily sensors, and cameras in the physical play space locations to generate a fused physical location of each participant in their real-world play spaces. These will be registered to three-dimensional locations within the virtual environment, and the AI model will output virtual positioning information of each of the physical human participants as well as each of the four virtual participants. For example, this model understands that, at a time point t, the pediatric patient is lying in the hospital bed, the human participant simulating a doctor is standing to the right of the bed, the human participant simulating an ICU nurse is in the room standing in front of the pyxis machine. This information will be encoded into a graphical context representation for use at any time point throughout the scenario, stored in the simulation system.
A model will use eye tracking data to determine the location of the gaze and infer what the participant is looking at. Physical pupillometry data collected by pupillometric sensors will be combined with virtual visual information in the field of view of the participant. Fusing these multimodal data sources, a computer vision model would determine semantic labels of objects in the scene and identify the area(s) of focus of the human participants based on the trajectory of their pupils. In this example, the model would be able to, at time point t, understand that participant simulating the doctor is looking at the virtual avatar representing the patient's father.
A machine learning model fuses the tracking of dialogue spoken during the scenario, performing temporal registration of the audio inputs from two sources: audio data sensed from the physical microphones in each of the actual play spaces, and the audio generated by the scenario system. A machine learning model will be trained on this preprocessed dialogue data, which could be transcribed into text and processed by the natural language processing system. This model will take the data and fuse this with the registered location data to identify the person or virtual avatar who spoke a piece of audio. For an example, at time point t, this understanding model will be able to understand that the human participant (doctor) is saying “based on your child's chart, I am concerned that they are having an asthma attack.” This will be encoded into a context memory database to which the system can refer throughout the scenario simulation. As another example, the human participant simulating the doctor may be looking at a blood pressure cuff and say out loud “Please apply this to the patient.” Based on fusing head tracking data for the human participant simulating the doctor in the virtual scene, the model will designate that “this” refers to the blood pressure cuff, and a higher-order model would then designate the virtual character of the simulated nurse to pick up the blood pressure cuff and apply it to virtual character of the pediatric patient through conversion into system commands.
A procedural model can work to understand that a physical movement correlates with a certain procedure in the virtual environment. Using the physical-virtual fused spatial data with information about the virtual orientation about tools
   There will also be higher-order inferential models that will fuse lower level inputs into more complex understanding outputs.
As an example, the higher-order model could understand what procedures/actions have been taken by all characters in the scene. For example, knowing that the human nurse participant is drawing up a steroid medication into a syringe through the fusion of positional tracking, virtual environment space, and finger tracking.
The machine learning model could fuse raw inputs about the participant to form an understanding about their sentiment. For example, there could be facial data from cameras fused with pose estimation data in the real world, alongside raw or processed audio inputs to detect linguistic and tonal context of spoken audio, enabling the detection of emotional context that would be included for higher-level response processing in order generate response commands. The model could similarly detect and infer stress using biometric sensor data, audio data, and facial expression data.
In order to simulate interprofessional competencies, the model could fuse the dialogue information, the spatial information, the sentiment information, and the virtual scenario information to determine if dialogue meets the communication skills outlined as learning objectives. For example, using the positional tracking information of human participants simulating the roles of the doctor and ICU nurse as well as virtual locations of the virtual characters, the model could fuse recorded voice and language, eye tracking and head tracking positions, and physical movements to determine if human participant simulating the doctor has adequately instructed and made eye contact with each human and virtual team member.
In another example, the command system could fuse voice recordings, eye tracking and other physical sensor data with virtual world positioning and the relative locations of other virtual participants in order to alter the level of perceived stress (as measured by the fused sensor data) through alterations in the virtual environment and scenario (as generated by commands) in order to yield changes in the human participant's perceived stress in order to maintain a certain predefined educational stress range.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving a set of tracking data from one or more sensors in a virtual or augmented reality environment, wherein the tracking data identifies one or more physical properties of a participant in a simulation executing within the virtual or augmented reality environment;
mapping the set of tracking data to coordinates within the virtual or augmented reality environment;
generating, using an artificial intelligence model, a set of one or more inferences based at least in part on the set of tracking data and the coordinates within the virtual or augmented reality environment;
translating the inferences into a set of instructions for causing at least one virtual avatar or object to react in the virtual or augmented reality environment; and
executing the set of instructions that cause the at least one virtual avatar or object to react in the virtual or augmented reality environment.

2. The method of claim 1, further comprising:
receiving audio input from the participant;
wherein the set of one or more inferences is further generated based at least in part on the audio input.

3. The method of claim 1,
wherein the tracking data includes eye tracking data from a sensor that tracks position information of at least one pupil of the participant; and
wherein the set of one or more inferences is further generated based at least in part on the eye tracking data.

4. The method of claim 1,
wherein the tracking data include hand and/or finger tracking data that tracks position information of at least one hand and/or finger of the participant;
wherein the set of one or more inferences is further generated based at least in part on the hand and/or finger tracking data.

5. The method of claim 1,
wherein the tracking data includes biomarker data from one or more biomarker sensors that track one or more biomarkers indicative of an emotional state of the participant; and
wherein the set of one or more inferences is further generated based at least in part on the one or more biomarkers indicative of the emotional state of the participant.

6. The method of claim 1, further comprising:
training, by at least one machine learning algorithm, the artificial intelligence model using a set of training data the includes sensor measurements within an augmented or virtual reality environment.

7. The method of claim 1, wherein translating the inferences into a set of instructions for causing at least one virtual avatar or object to react in the virtual or augmented reality environment comprises:
generating, based on the set of one or more inferences using a generative language model, an audio encoding that causes a vocalization from a virtual avatar.

8. The method of claim 1, wherein translating the inferences into a set of instructions for causing at least one virtual avatar or object to react in the virtual or augmented reality environment comprises:
causing the virtual avatar to perform an action within the simulation.

9. The method of claim 1, wherein translating the inferences into a set of instructions for causing at least one virtual avatar or object to react in the virtual or augmented reality environment comprises:
updating an objective in a training simulation; wherein the reaction of the virtual avatar or virtual object is further based on the updated objective.

10. The method of claim 1, further comprising:
translating the inferences into a set of instructions for controlling haptic feedback on a device worn or held by the participant; and
executing the set of instructions to change a current state of the haptic feedback on the device worn or held by the participant.

11. (canceled)

12. (canceled)
